(19) United States
(12) Patent Application Publication
(10) Pub. No.: US 2022/0173377 A1
(43) Pub. Date: Jun. 2, 2022

(54) THICK ELECTRODES FOR ELECTROCHEMICAL CELLS

(71) Applicant: GM Global Technology Operations LLC, Detroit, MI (US)

(72) Inventors: Dewen KONG, Shanghai (CN); Xiaochao QUE, Shanghai (CN); Haijing LIU, Shanghai (CN); Xiaosong HUANG, Novi, MI (US); Mark W. VERBRUGGE, Troy, MI (US); Meiyuan WU, Shanghai (CN)

(73) Assignee: GM Global Technology Operations LLC, Detroit, MI (US)

(21) Appl. No.: 17/539,901

(22) Filed: Dec. 1, 2021

(30) Foreign Application Priority Data
Dec. 2, 2020 (CN) 202011391714.1

(51) Int. Cl. H01M 4/136; H01M 4/58; H01M 4/66; H01M 4/62; H01M 10/0525

(52) U.S. Cl. CPC H01M 4/136; H01M 4/5825; H01M 4/667; H01M 2004/021; H01M 4/668; H01M 10/0525; H01M 4/622

(57) ABSTRACT

The present disclosure relates to high capacity (e.g., areal capacity greater than about 4 mAh/cm² to less than or equal to about 50 mAh/cm²) electrodes for electrochemical cells. An example electrode may include a current collector (e.g., meshed current collector) and one or more electroactive material layers having thicknesses greater than about 150 μm to less than or equal to about 5 mm. The electroactive material layers may each include lithium manganese iron phosphate (LiMnₓFe₁₋ₓPO₄, where 0≤x≤1) (LMFP). The electrode may further include one or more electronically conductive adhesive layers disposed between the current collector and the electroactive material layers. The adhesive layers may include one or more polymer components and one or more conductive fillers. The electroactive material layers may be gradient layers, where sublayers closer to the current collector has a lower porosity than layers further from the current collector.

This application claims the benefit and priority of Chinese Patent Application No. 202011391714.1, filed Dec. 2, 2020. The entire disclosure of the above application is incorporated herein by reference.

### INTRODUCTION

This section provides background information related to the present disclosure which is not necessarily prior art.

Advanced energy storage devices and systems are in demand to satisfy energy and/or power requirements for a variety of products, including automotive products such as start-stop systems (e.g., 12V start-stop systems), battery-assisted systems, hybrid electric vehicles (“HEVs”), and electric vehicles (“EVs”). Typical lithium-ion batteries include at least two electrodes and an electrolyte and/or separator. One of the two electrodes may serve as a positive electrode or cathode and the other electrode may serve as a negative electrode or anode. A separator and/or electrolyte may be disposed between the negative and positive electrodes. The electrolyte is suitable for conducting lithium ions between the electrodes and, like the two electrodes, may be in solid and/or liquid form and/or a hybrid thereof. Liquid electrolytes may include one or more lithium salts dissolved in an organic solvent or a mixture of organic solvents. Liquid electrolytes fill voids and pores in separators, and in certain aspects, negative and/or positive electrodes. In instances of solid-state batteries, which include solid-state electrodes and a solid-state electrolyte, the solid-state electrolyte may physically separate the electrodes so that a distinct separator is not required.

Conventional rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of intercalated lithium (such as in the instance of graphite-containing anodes), which is oxidized into lithium ions and electrons. Lithium ions may travel from the negative electrode to the positive electrode, for example, through the ionically conductive electrolyte solution contained within the pores of an interposed porous separator. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge.

Many different materials may be used to create components for a lithium ion battery. For example, positive electrode materials for lithium batteries typically comprise an electroactive material which can be intercalated with lithium ions, such as lithium-transition metal oxides or mixed oxides, for example including LiMn₂O₄, LiCoO₂, LiNiO₂, LiMn_{1.5}Ni_{0.5}O₄, LiNi_{(1-x-y)}CoₓM_{y}O₂ (where 0<x<1, y<1, and M may be Al, Mn, or the like), or one or more phosphate compounds, for example including lithium iron phosphate or mixed lithium manganese-iron phosphate. The negative electrode typically includes a lithium insertion material or an alloy host material. For example, typical electroactive materials for forming an anode include graphite and other forms of carbon, silicon and silicon oxide, tin and tin alloys.

Certain cathode materials have particular advantages. For example, some electroactive materials, such as lithium manganese iron phosphate (LiMnFePO₄) (LMFP), are capable of high energy density (e.g., about 700 Wh/kg) and long lives. However, these materials may have properties, such as large specific surface areas, high interparticle porosities, and low tap densities, that present certain challenges, especially in the creation of electrodes having sufficient loading capabilities and/or thick electrodes. For example, low-tap-density materials may be difficult to incorporate in traditional wet coating processes because particles of the electroactive material tend to spread out from one another, creating, for example, thin electrodes (e.g., 40 μm-100 μm) having a low energy density and limited capacity loading (e.g., <4 mAh/cm², optionally about 1.1 mAh/cm²). Moreover, electrodes including low-tap-density materials that are fabricated in wet coating processes may be susceptible to cracking after drying. Accordingly, it would be desirable to develop electrode materials, and methods for preparing such electrode materials, as well as the electrochemical cell including the electrode materials, that overcome and/or accommodate such material properties while allowing for thick electrode designs.

### SUMMARY

This section provides a general summary of the disclosure, and is not a comprehensive disclosure of its full scope or all of its features.

The present disclosure relates to high capacity electrodes for electrochemical cells. The electrodes include lithium manganese iron phosphate (LiMnₓFe₁₋ₓPO₄, where 0≤x≤1) (LMFP) and have thicknesses greater than about 150 μm to less than or equal to about 5 mm. The electrode can have areal capacities greater than about 4 mAh/cm² to less than or equal to about 50 mAh/cm².

In various aspects, the present disclosure provides an electrode for an electrochemical cell. The electrode includes a current collector and one or more electroactive material layers disposed adjacent to one or more exposed surfaces of the current collector. The one or more electroactive material layers may each include lithium manganese iron phosphate (LiMnₓFe₁₋ₓPO₄, where 0≤x≤1) (LMFP) and may have a thickness greater than about 150 μm to less than or equal to about 5 mm. The electrode may have an areal capacity greater than about 4 mAh/cm² to less than or equal to about 50 mAh/cm².

In one aspect, the electrode may further include one or more electronically conductive adhesive layers disposed between the current collector and the one or more electroactive material layers.

In one aspect, each of the one or more electronically conductive adhesive layers may have a thickness greater than or equal to about 0.5 μm to less than or equal to about 20 μm.

In one aspect, each of the one or more electronically conductive adhesive layers may include greater than or equal to about 0.1 wt. % to less than or equal to about 50 wt. % of one or more polymer components, and greater than or equal to about 0.1 wt. % to less than or equal to about 50 wt. % of one or more conductive fillers.

In one aspect, the one or more polymer components may be selected from the group consisting of polyacrylic acid (PAA), epoxy, polyimide, polyester, polyacrylate, vinyl ester, polyvinylidene fluoride (PVdF), polyamide, silicon, acrylic, and combinations thereof. The one or more conductive fillers may be selected from the group consisting of: carbon black, graphene, carbon nanotubes, carbon nanofibers, metal powders, conductive polymers, and combinations thereof.

In one aspect, the current collector may be a meshed current collector having a porosity greater than or equal to about 0.01 vol. % to less than or equal to about 50 vol. % and an average pore size greater than or equal to about 5 nm to less than or equal to about 500 μm.

In one aspect, the one or more electroactive material layers may be pressed into pores of the meshed current collector during fabrication.

In one aspect, at least one of the one or more electroactive material layers may include one or more sublayers having different interparticle porosities. Sublayers of the one or more sublayers having lower interparticle porosities may be disposed nearer to the current collector and sublayers of the one or more sublayers having higher interparticle porosities may be disposed further from the current collector.

In one aspect, the one or more sublayers may include a first sublayer having a first interparticle porosity and a second sublayer having a second interparticle porosity. The second interparticle porosity may be larger than the first interparticle porosity. The first sublayer may be disposed adjacent to the current collector and the second sublayer may be disposed adjacent to an exposed surface of the first sublayer.

In one aspect, at least one of the one or more electroactive material layers may have a thickness greater than about 150 μm to less than or equal to about 500 μm. The areal capacity of the electrode may be greater than or equal to about 4.5 mAh/cm² to less than or equal to about 7.5 mAh/cm².

In one aspect, the at least one of the one or more electroactive material layers includes one or more of LiMn_{0.7}Fe_{0.3}PO₄, LiMn_{0.6}Fe_{0.4}PO₄, LiMn_{0.8}Fe_{0.2}PO₄ and LiMn_{0.75}Fe_{0.25}PO₄.

In one aspect, the one or more electroactive material layers are doped with one or more dopants selected from magnesium (Mg), aluminum (Al), yttrium (Y), scandium (Sc), and combinations thereof.

In one aspect, the electrode may have a press density of greater than or equal to about 1.0 g/cc to less than or equal to about 3.0 g/cc and an interparticle porosity greater than or equal to about 25 vol. % to less than or equal to about 60 vol. %.

In one aspect, at least one of the one or more electroactive material layers includes greater than or equal to about 80 wt. % to less than or equal to about 98 wt. % of the lithium manganese iron phosphate (LiMnₓFe₁₋ₓPO₄, where 0≤x≤1) (LMFP). The at least one of the one or more electroactive material layers may further include greater than or equal to about 0.5 wt. % to less than or equal to about 10 wt. % of one or more binders; and greater than or equal to about 0.5 wt. % to less than or equal to about 15 wt. % of one or more conductive fillers.

In various aspects, the present disclosure provides an example electrode for an electrochemical cell. The electrode includes a current collector, an electroactive material layer, and an electronically conductive adhesive layer disposed between the current collector and the electroactive material layer. The electroactive material layer includes lithium manganese iron phosphate (LiMnₓFe₁₋ₓPO₄, where 0≤x≤1) (LMFP) and has a thickness greater than about 150 μm to less than or equal to about 500 μm. The electronically conductive adhesive layer may include greater than or equal to about 0.1 wt. % to less than or equal to about 50 wt. % of one or more polymer components, and greater than or equal to about 0.1 wt. % to less than or equal to about 50 wt. % of one or more conductive fillers. The electronically conductive adhesive layer may have a thickness greater than or equal to about 0.5 μm to less than or equal to about 20 μm.

In one aspect, the current collector may be a meshed current collector having a porosity greater than or equal to about 0.01 vol. % to less than or equal to about 50 vol. % and an average pore size greater than or equal to about 5 nm to less than or equal to about 500 μm.

In one aspect, the electroactive material layer includes a first sublayer having a first interparticle porosity and a second sublayer having a second interparticle porosity. The second interparticle porosity may be larger than the first interparticle porosity and the first sublayer may be disposed adjacent to the current collector. The second sublayer is disposed adjacent to an exposed surface of the first sublayer.

In various aspects, the present disclosure provides an example electrode for an electrochemical cell. The electrode includes a current collector and an electroactive material layer disposed adjacent to an exposed surface of the current collector. The electroactive material layer may have a thickness greater than about 150 μm to less than or equal to about 500 μm, The electroactive material layer may include a first sublayer having a first interparticle porosity, and a second sublayer having a second interparticle porosity. The second interparticle porosity may be larger than the first interparticle porosity. The first sublayer may be disposed adjacent to the current collector. The second sublayer may be disposed adjacent to an exposed surface of the first sublayer. The first sublayer and the second sublayer may each include lithium manganese iron phosphate (LiMnₓFe₁₋ₓPO₄, where 0≤x≤1) (LMFP).

In one aspect, the current collector may be a meshed current collector having a porosity greater than or equal to about 0.01 vol. % to less than or equal to about 50 vol. % and an average pore size greater than or equal to about 5 nm to less than or equal to about 500 μm.

In one aspect, the electrode may further include an electronically conductive adhesive layer disposed between the current collector and the first sublayer. The electronically conductive adhesive layer may have a thickness greater than or equal to about 0.5 μm to less than or equal to about 20 μm.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a schematic of an example electrochemical battery cell;

FIG. 2 illustrates an example electrode including one or more electroactive material layers having thicknesses greater than about 150 μm in accordance with various aspects of the current technology;

FIG. 3 illustrates an example electrode including one or more electroactive material layers having thicknesses greater than about 150 μm and an electronically conductive adhesive layer in accordance with various aspects of the current technology;

FIG. 4 illustrates an example electrode including one or more electroactive layers having thicknesses greater than about 150 μm disposed adjacent to one or more surfaces of a mesh current collector in accordance with various aspects of the current technology;

FIG. 5 illustrates an example electrode including one or more electroactive layers including first sublayers having first interparticle porosities and second sublayers having second interparticle porosities in accordance with various aspects of the current technology;

FIG. 6 is a graphical illustration of an areal capacity (mAh/cm²) and voltage (V) for a half coin electrochemical cell including an example electrode prepared in accordance with various aspects of the certain technology;

FIG. 7 is a graphical illustration of an areal capacity (mAh/cm²) and voltage (V) for a half coin electrochemical cell including an example electrode prepared in accordance with various aspects of the certain technology;

FIG. 8 is a graphical illustration of an areal capacity (mAh/cm²) and voltage (V) for a half coin electrochemical cell including an example electrode prepared in accordance with various aspects of the certain technology;

FIG. 9A is a graphical illustration of capacity (Ah) and voltage (V) for a pouch cell including an example electrode prepared in accordance with various aspects of the certain technology;

FIG. 9B is another graphical illustration of capacity (Ah) and voltage (V) for the example pouch cell including an example electrode prepared in accordance with various aspects of the certain technology;

FIG. 9C is another graphical illustration of capacity (Ah) and voltage (V) for the example pouch cell including an example electrode prepared in accordance with various aspects of the certain technology; and

FIG. 9D is a graphical illustration of capacity retention (%) for the example pouch cell at C/3 including an example electrode prepared in accordance with various aspects of the certain technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The present disclosure relates to high capacity electrodes for electrochemical cells. The electrodes include lithium manganese iron phosphate (LiMnₓFe₁₋ₓPO₄, where 0≤x≤1) (LMFP) and have thicknesses greater than about 150 μm to less than or equal to about 5 mm, and in certain aspects, greater than about 150 μm to less than or equal to about 2 mm. The electrode can have areal capacities greater than about 4 mAh/cm² to less than or equal to about 50 mAh/cm².

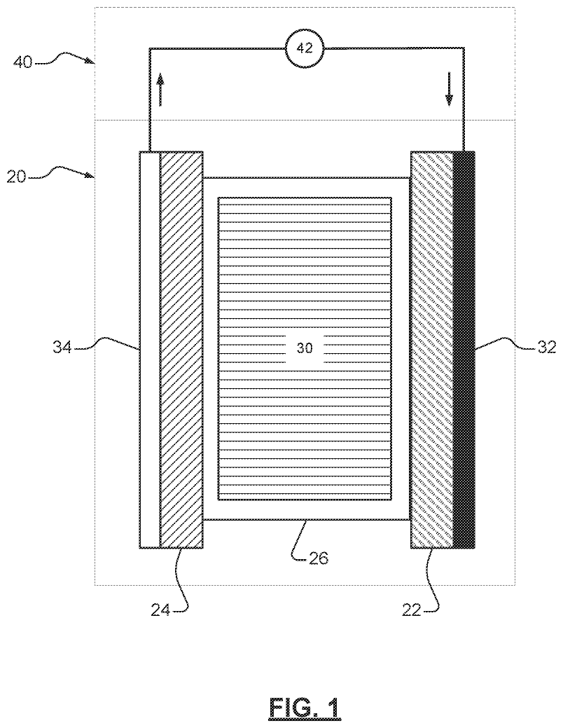

A typical lithium-ion battery (e.g., electrochemical cell that cycles lithium ions) includes a first electrode (such as, a positive electrode or cathode) opposing a second electrode (such as, a negative electrode or anode) and a separator and/or electrolyte disposed therebetween. Often, in a lithium-ion battery pack, batteries or cells may be electrically connected in a stack or winding configuration to increase overall output. Lithium-ion batteries operate by reversibly passing lithium ions between the first and second electrodes. For example, lithium ions may move from a positive electrode to a negative electrode during charging of the battery, and in the opposite direction when discharging the battery. The electrolyte is suitable for conducting lithium ions (or sodium ions in the case of sodium-ion batteries, and the like) and may be in liquid, gel, or solid form. For example, exemplary and schematic illustration of an electrochemical cell (also referred to as a battery) 20 is shown in FIG. 1.

Such cells are used in vehicle or automotive transportation applications (e.g., motorcycles, boats, tractors, buses, motorcycles, mobile homes, campers, and tanks). However, the current technology may be employed in a wide variety of other industries and applications, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. Further, although the illustrated examples include a single cathode and a single anode, the skilled artisan will recognize that the current teaching extend to various other configurations, including those having one or more cathodes and one or more anodes, as well as various current collectors with electroactive layers disposed on or adjacent to one or more surfaces thereof.

As illustrated in FIG. 1, the battery 20 includes a negative electrode 22 (e.g., anode), a positive electrode 24 (e.g., cathode), and a separator 26 disposed between the two electrodes 22, 24. The separator 26 provides electrical separation-prevents physical contact-between the electrodes 22, 24. The separator 26 also provides a minimal resistance path for internal passage of lithium ions, and in certain instances, related anions, during cycling of the lithium ions. In various aspects, the separator 26 comprises an electrolyte 30 that may, in certain aspects, also be present in the negative electrode 22 and the positive electrode 24. In certain variations, the separator 26 may be formed by a solid-state electrolyte 30. For example, the separator 26 may be defined by a plurality of solid-state electrolyte particles (not shown).

A negative electrode current collector 32 may be positioned at or near the negative electrode 22, and a positive electrode current collector 34 may be positioned at or near the positive electrode 24. The negative electrode current collector 32 may be a metal foil (e.g., solid or meshed or clad foil), metal grid or screen, or expanded metal comprising copper or any other appropriate electrically conductive material known to those of skill in the art. In certain variations, a surface of the negative electrode current collector 32 may comprise a metal foil that is surface treated, for example, carbon coated and/or etched. In each instance, the negative electrode current collector 32 may have a thickness greater than or equal to about 4 μm to less than or equal to about 50 μm and in certain aspects, optionally about 6 μm. The positive electrode current collector 34 may be a metal foil (e.g., solid or meshed or clad foil), metal grid or screen, or expanded metal comprising aluminum or any other appropriate electrically conductive material known to those of skill in the art. In certain variations, a surface of a positive electrode current collector 34 may comprise a metal foil that is surface treated, for example, carbon coated and/or etched. In each instance, the positive electrode current collector 34 may have a thickness greater than or equal to about 5 μm to less than or equal to about 50 μm and in certain aspects, optionally about 12 μm.

The negative electrode current collector 32 and the positive electrode current collector 34 respectively collect and move free electrons to and from an external circuit 40. For example, an interruptible external circuit 40 and a load device 42 may connect the negative electrode 22 (through the negative electrode current collector 32) and the positive electrode 24 (through the positive electrode current collector 34).

The battery 20 can generate an electric current during discharge by way of reversible electrochemical reactions that occur when the external circuit 40 is closed (to connect the negative electrode 22 and the positive electrode 24) and the negative electrode 22 has a lower potential than the positive electrode. The chemical potential difference between the positive electrode 24 and the negative electrode 22 drives electrons produced by a reaction, for example, the oxidation of intercalated lithium, at the negative electrode 22 through the external circuit 40 towards the positive electrode 24. Lithium ions that are also produced at the negative electrode 22 are concurrently transferred through the electrolyte 30 contained in the separator 26 towards the positive electrode 24. The electrons flow through the external circuit 40 and the lithium ions migrate across the separator 26 containing the electrolyte 30 to form intercalated lithium at the positive electrode 24. As noted above, electrolyte 30 is typically also present in the negative electrode 22 and positive electrode 24. The electric current passing through the external circuit 40 can be harnessed and directed through the load device 42 until the lithium in the negative electrode 22 is depleted and the capacity of the battery 20 is diminished.

The battery 20 can be charged or re-energized at any time by connecting an external power source (e.g., charging device) to the lithium ion battery 20 to reverse the electrochemical reactions that occur during battery discharge. Connecting an external electrical energy source to the battery 20 promotes a reaction, for example, non-spontaneous oxidation of intercalated lithium, at the positive electrode 24 so that electrons and lithium ions are produced. The lithium ions flow back towards the negative electrode 22 through the electrolyte 30 across the separator 26 to replenish the negative electrode 22 with lithium (e.g., intercalated lithium) for use during the next battery discharge event. As such, a complete discharging event followed by a complete charging event is considered to be a cycle, where lithium ions are cycled between the positive electrode 24 and the negative electrode 22. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator.

In many lithium-ion battery configurations, each of the negative electrode current collector 32, negative electrode 22, separator 26, positive electrode 24, and positive electrode current collector 34 are prepared as relatively thin layers (for example, from several microns to a fraction of a millimeter or less in thickness) and assembled in layers connected in electrical parallel arrangement to provide a suitable electrical energy and power package. In various aspects, the battery 20 may also include a variety of other components that, while not depicted here, are nonetheless known to those of skill in the art. For instance, the battery 20 may include a casing, gaskets, terminal caps, tabs, battery terminals, and any other conventional components or materials that may be situated within the battery 20, including between or around the negative electrode 22, the positive electrode 24, and/or the separator 26. The battery 20 shown in FIG. 1 includes a liquid electrolyte 30 and shows representative concepts of battery operation. However, the current technology also apply to solid-state batteries that include solid-state electrolytes (and solid-state electroactive particles) that may have a different design, as known to those of skill in the art.

As noted above, the size and shape of the battery 20 may vary depending on the particular application for which it is designed. Battery-powered vehicles and hand-held consumer electronic devices, for example, are two examples where the battery 20 would most likely be designed to different size, capacity, and power-output specifications. The battery 20 may also be connected in series or parallel with other similar lithium-ion cells or batteries to produce a greater voltage output, energy, and power if it is required by the load device 42. Accordingly, the battery 20 can generate electric current to a load device 42 that is part of the external circuit 40. The load device 42 may be fully or partially powered by the electric current passing through the external circuit 40 when the battery 20 is discharging. While the electrical load device 42 may be any number of known electrically-powered devices, a few specific examples include an electric motor for an electrified vehicle, a laptop computer, a tablet computer, a cellular phone, and cordless power tools or appliances. The load device 42 may also be an electricity-generating apparatus that charges the battery 20 for purposes of storing electrical energy.

With renewed reference to FIG. 1, the positive electrode 24, the negative electrode 22, and the separator 26 may each include an electrolyte solution or system 30 inside their pores, capable of conducting lithium ions between the negative electrode 22 and the positive electrode 24. Any appropriate electrolyte 30, whether in solid, liquid, or gel form, capable of conducting lithium ions between the negative electrode 22 and the positive electrode 24 may be used in the lithium-ion battery 20. For example, the electrolyte 30 may be a non-aqueous liquid electrolyte solution (e.g., >1M) that includes a lithium salt dissolved in an organic solvent or a mixture of organic solvents. In certain instances, the electrolyte 30 may also include one or more additives, such as vinylene carbonate (VC), butylene carbonate (BC), fluoroethylene carbonate (FEC), and the like. Numerous conventional non-aqueous liquid electrolyte solutions may be employed in the lithium-ion battery 20.

In certain aspects, the electrolyte 30 may be a non-aqueous liquid electrolyte solution that includes one or more lithium salts dissolved in an organic solvent or a mixture of organic solvents. The lithium salts may include one or more cations coupled with one or more anions. The cations may be selected from Li⁺, Na⁺, K⁺, Al³⁺, Mg²⁺, and the like. The anions may be selected from PF⁶⁻, BF⁴⁻, TFSI⁻, FSI⁻, CF₃SO₃₋, (C₂F₅S₂O₂)N⁻, and the like. For example, a non-limiting list of lithium salts that may be dissolved in an organic solvent to form the non-aqueous liquid electrolyte solution include lithium hexafluorophosphate (LiPF₆), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium tetraphenylborate (LiB(C₆H₅)₄), lithium bis(oxalato)borate (LiB(C₂O₄)₂) (LiBOB), lithium difluorooxalatoborate (LiBF₂(C₂O₄)), lithium hexafluoroarsenate (LiAsF₆), lithium trifluoromethanesulfonate (LiCF₃SO₃), lithium bis(trifluoromethane)sulfonylimide (LiN(CF₃SO₂)₂), lithium bis(fluorosulfonyl)imide (LiN(FSO₂)₂) (LiSFI), and combinations thereof.

These and other similar lithium salts may be dissolved in a variety of non-aqueous aprotic organic solvents, including but not limited to, various alkyl carbonates (arbonates), such as cyclic carbonates (e.g., ethylene carbonate (EC), propylene carbonate (PC), butylene carbonate (BC), fluoroethylene carbonate (FEC)), linear carbonates (e.g., dimethyl carbonate (DMC), diethyl carbonate (DEC), ethylmethylcarbonate (EMC)), aliphatic carboxylic esters (e.g., methyl formate, methyl acetate, methyl propionate), γ-lactones (e.g., γ-butyrolactone, γ-valerolactone), chain structure ethers (e.g., 1,2-dimethoxyethane, 1-2-diethoxyethane, ethoxymethoxyethane), cyclic ethers (e.g., tetrahydrofuran, 2-methyltetrahydrofuran), 1,3-dioxolane), sulfur compounds (e.g., sulfolane), and combinations thereof.

The porous separator 26 may include, in certain instances, a microporous polymeric separator including a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyethylene (PE), polypropylene (PP), or a blend of polyethylene (PE) and polypropylene (PP), or multi-layered structured porous films of PE and/or PP. Commercially available polyolefin porous separator membranes 26 include CELGARD® 2500 (a monolayer polypropylene separator) and CELGARD®2320 (a trilayer polypropylene/polyethylene/polypropylene separator) available from Celgard LLC.

In certain aspects, the separator 26 may further include one or more of a ceramic coating layer and a heat-resistant material coating. The ceramic coating layer and/or the heat-resistant material coating may be disposed on one or more sides of the separator 26. The material forming the ceramic layer may be selected from the group consisting of: alumina (Al₂O₃), silica (SiO₂), and combinations thereof. The heat-resistant material may be selected from the group consisting of: Nomex, Aramid, and combinations thereof.

When the separator 26 is a microporous polymeric separator, it may be a single layer or a multi-layer laminate, which may be fabricated from either a dry or a wet process. For example, in certain instances, a single layer of the polyolefin may form the entire separator 26. In other aspects, the separator 26 may be a fibrous membrane having an abundance of pores extending between the opposing surfaces and may have an average thickness of less than a millimeter, for example. As another example, however, multiple discrete layers of similar or dissimilar polyolefins may be assembled to form the microporous polymer separator 26. The separator 26 may also comprise other polymers in addition to the polyolefin such as, but not limited to, polyethylene terephthalate (PET), polyvinylidene fluoride (PVdF), a polyamide, polyimide, poly(amide-imide) copolymer, polyetherimide, and/or cellulose, or any other material suitable for creating the required porous structure. The polyolefin layer, and any other optional polymer layers, may further be included in the separator 26 as a fibrous layer to help provide the separator 26 with appropriate structural and porosity characteristics. In certain aspects, the separator 26 may also be mixed with a ceramic material or its surface may be coated in a ceramic material. For example, a ceramic coating may include alumina (Al₂O₃), silicon dioxide (SiO₂), titania (TiO₂) or combinations thereof. Various conventionally available polymers and commercial products for forming the separator 26 are contemplated, as well as the many manufacturing methods that may be employed to produce such a microporous polymer separator 26. The separator 26 may have a thickness greater than or equal to about 1 μm to less than or equal to about 50 μm, and in certain instances, optionally greater than or equal to about 1 μm to less than or equal to about 20 μm.

In various aspects, the porous separator 26 and the electrolyte 30 in FIG. 1 may be replaced with a solid-state electrolyte (“SSE”) (not shown) that functions as both an electrolyte and a separator. The solid-state electrolyte may be disposed between the positive electrode 24 and negative electrode 22. The solid-state electrolyte facilitates transfer of lithium ions, while mechanically separating and providing electrical insulation between the negative and positive electrodes 22, 24. By way of non-limiting example, solid-state electrolytes may include a plurality of solid-state electrolyte particles such as LiTi₂(PO₄)₃, LiGe₂(PO₄)₃, Li₇La₃Zr₂O₁₂, Li₃ₓLa_{2/3-x}TiO₃, Li₃PO₄, Li₃N, Li₄GeS₄, Li₁₀GeP₂Si₂, Li₂S—P₂S₅, Li₆PS₅Cl, Li₆PS₅Br, Li₆PS₅I, Li₃OCl, Li_{2.99}Ba_{0.005}ClO, or combinations thereof. The solid-state electrolyte particles may be nanometer sized oxide-based solid-state electrolyte particles. In still other variations, the porous separator 26 and the electrolyte 30 in FIG. 1 may be a gel electrolyte.

The negative electrode 22 comprises a lithium host material that is capable of functioning as a negative terminal of a lithium-ion battery. For example, the negative electrode 22 may comprise a lithium host material (e.g., negative electroactive material) that is capable of functioning as a negative terminal of the battery 20. In various aspects, the negative electrode 22 may be defined by a plurality of negative electroactive material particles (not shown). Such negative electroactive material particles may be disposed in one or more layers so as to define the three-dimensional structure of the negative electrode 22. The electrolyte 30 may be introduced, for example after cell assembly, and contained within pores (not shown) of the negative electrode 22. For example, the negative electrode 22 may include a plurality of electrolyte particles (not shown). The negative electrode 22 (including the one or more layers) may have a thickness greater than or equal to about 1 μm to less than or equal to about 2000 μm, and in certain aspects, optionally greater than or equal to about 10 μm to less than or equal to about 1000 μm.

The negative electrode 22 may include a negative electroactive material that comprises lithium, such as, for example, lithium metal. In certain variations, the negative electrode 22 is a film or layer formed of lithium metal or an alloy of lithium. Other materials can also be used to form the negative electrode 22, including, for example, carbonaceous materials (such as graphite, hard carbon, soft carbon), lithium-silicon and silicon containing binary and ternary alloys and/or tin-containing alloys (such as Si, Li—Si, SiOx Si—Sn, SiSnFe, SiSnAl, SiFeCo, SnO₂, and the like), and/or metal oxides (such as Fe₃O₄). In certain alternative embodiments, lithium-titanium anode materials are contemplated, such as Li₄₊ₓTi₅O₁₂, where 0≤x≤3, including lithium titanate (Li₄Ti₅O₁₂) (LTO).

The negative electroactive material may be optionally intermingled with one or more electrically conductive materials that provide an electron conductive path and/or at least one polymeric binder material that improves the structural integrity of the negative electrode 22. For example, the negative electroactive material in the negative electrode 22 may be optionally intermingled with binders such as bare alginate salts, poly(tetrafluoroethylene) (PTFE), sodium carboxymethyl cellulose (CMC), styrene-butadiene rubber (SBR), poly(vinylidene fluoride) (PVDF), nitrile butadiene rubber (NBR), styrene ethylene butylene styrene copolymer (SEBS), styrene butadiene styrene copolymer (SBS), polyacrylate (PAA), lithium polyacrylate (LiPAA), sodium polyacrylate (NaPAA), sodium alginate, lithium alginate, ethylene propylene diene monomer (EPDM), and combinations thereof. Electrically conductive materials may include carbon-based materials, powder nickel or other metal particles, or a conductive polymer. Carbon-based materials may include, for example, particles of carbon black (e.g., Super-P), graphite, acetylene black (such as KETCHEN™ black or DENKA™ black), carbon fibers and nanotubes (e.g., vapor grown carbon fibers (VGCF)), graphene, graphene oxide, and the like. Examples of a conductive polymer include polyaniline, polythiophene, polyacetylene, polypyrrole, and the like.

For example, the negative electrode 22 may include greater than or equal to about 30 wt. % to less than or equal to about 99.5 wt. %, and in certain aspects, optionally greater than or equal to about 50 wt. % to less than or equal to about 95 wt. %, of the negative electroactive material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

The positive electrode 24 may be formed from a lithium-based active material that is capable of undergoing lithium intercalation and deintercalation, alloying and dealloying, or plating and stripping, while functioning as the positive terminal of the battery 20. For example, the positive electrode 24 can be defined by a plurality of electroactive material particles (not shown) disposed in one or more layers so as to define the three-dimensional structure of the positive electrode 24. The electrolyte 30 may be introduced, for example after cell assembly, and contained within pores (not shown) of the positive electrode 24. For example, the positive electrode 24 may include a plurality of electrolyte particles (not shown). The positive electrode 24 (including the one or more layers) may have a thickness greater than about 150 μm.

The positive electrode 24 may comprise a positive electroactive material that has a low-tap-density material (e.g., less than or equal to about 2 g/cc) and/or that has large specific surface area (e.g., greater than or equal to about 20 m²/g) and/or that has small secondary particles sizes (e.g., D50 less than or equal to about 3 μm). For example, the positive electroactive material may comprise one or more lithium manganese iron phosphates (LiMnₓFe₁₋ₓPO₄, where 0≤x≤1) (LMFP), such as LiMn_{0.7}Fe_{0.3}PO₄, LiMn_{0.6}Fe_{0.4}PO₄, LiMn_{0.8}Fe_{0.2}PO₄, LiMn_{0.75}Fe_{0.25}PO₄, by way of non-limiting example. In certain aspects, the one or more lithium manganese iron phosphates (LiMnₓFe₁₋ₓPO₄, where 0≤x≤1) (LMFP) may be doped with one or more dopants, such as magnesium (Mg), aluminum (Al), yttrium (Y), scandium (Sc), and the like. For example, the positive electroactive material may include one or more of LiMn_{0.7}Mg_{0.05}Fe_{0.25}P₀₄, LiMn_{0.75}Al_{0.05}Fe_{0.2}PO₄, LiMn_{0.75}Al_{0.03}Fe_{0.22}PO₄, LiMn_{0.75}Al_{0.03}Fe_{0.22}PO₄, LiMn_{0.7}Y_{0.02}Fe_{0.28}PO₄, LiMn_{0.7}Mg_{0.02}Al_{0.03}Fe_{0.25}PO₄, and the like. The one or more lithium manganese iron phosphates (LiMnₓFe₁₋ₓPO₄, where 0≤x≤1) (LMFP) may be doped with about 10 wt. % of the one or more dopants.

In each instance, such lithium manganese iron phosphate (LiMnₓFe₁₋ₓPO₄, where 0≤x≤1) (LMFP) electroactive material particles may have an average primary particle size greater than or equal to about 10 nm to less than or equal to about 250 nm; a tap density greater than or equal to about 0.4 g/cc to less than or equal to about 2.0 g/cc, optionally about 0.4 g/cc to less than or equal to about 1 g/cc, optionally about 0.8 g/cc, and in certain aspects, optionally about 0.5 g/cc; and a specific area greater than or equal to about 3 m²/g to less than or equal to about 50 m²/g, and in certain aspects, optionally about 34.3 m²/g.

The positive electroactive materials may be optionally intermingled with an electronically conducting material that provides an electron conduction path and/or at least one polymeric binder material that improves the structural integrity of the electrode. For example, the positive electroactive materials and electronically or electrically conducting materials may be slurry cast with such binders, like polyvinylidene difluoride (PVdF), polytetrafluoroethylene (PTFE), ethylene propylene diene monomer (EPDM) rubber, or carboxymethyl cellulose (CMC), a nitrile butadiene rubber (NBR), styrene-butadiene rubber (SBR), polyacrylate (PAA), lithium polyacrylate (LiPAA), sodium polyacrylate (NaPAA), sodium alginate, or lithium alginate. Electrically conducting materials may include carbon-based materials, powdered nickel or other metal particles (e.g., metal wire and/or metal oxides), or a conductive polymer. Carbon-based materials may include, for example, particles of graphite, carbon black (such as Super-P), acetylene black (such as KETCHEN™ black or DENKA™ black), carbon fibers and nanotubes (e.g., vapor grown carbon fibers (VGCF)), graphene, graphene oxide, and the like. Examples of a conductive polymer include polyaniline, polythiophene, polyacetylene, polypyrrole, and the like. In certain aspects, mixtures of the conductive materials may be used.

For example, the positive electrode 24 may include greater than or equal to about 30 wt. % to less than or equal to about 98 wt. %, and in certain aspects, optionally greater than or equal to about 80 wt. % to less than or equal to about 95 wt. %, of the positive electroactive material; greater than or equal to about 0 wt. % to less than or equal to about 30 wt. %, and in certain aspects, optionally greater than or equal to about 0.5 wt. % to less than or equal to about 15 wt. %, of one or more electrically conductive materials; and greater than or equal to about 0 wt. % to less than or equal to about 20 wt. %, and in certain aspects, optionally greater than or equal to about 0.5 wt. % to less than or equal to about 10 wt. %, of one or more binders.

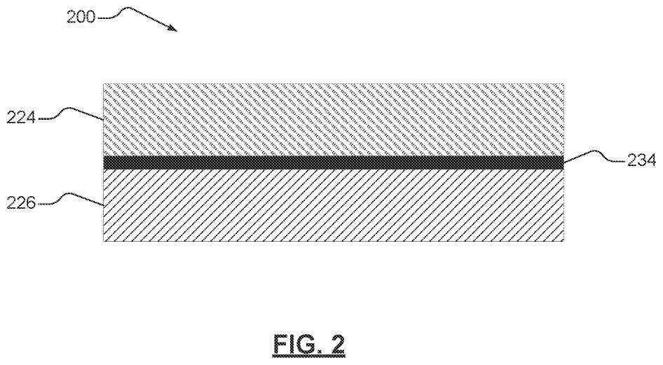

Certain cathode materials, such as lithium manganese iron phosphates (LiMnₓFe₁₋ₓPO₄, where 0≤x≤1) (LMFP) positive electroactive materials, have particular advantages. For example, lithium manganese iron phosphate (LiMnₓFe₁₋ₓPO₄, where 0≤x≤1) (LMFP) positive electroactive materials are capable of high energy density and long lives. However, as noted above, such lithium manganese iron phosphates (LiMnₓFe₁₋ₓPO₄, where 0≤x≤1) (LMFP) positive electroactive materials may have certain properties, such as large specific surface areas and low tap densities, that may present certain challenges, especially in the creation and maintenance of electrodes having sufficient loading capabilities (e.g., >4 mAh/cm²). In various aspects, the present disclosure provides positive electrodes having thicknesses greater than about greater than about 150 μm and areal capabilities greater than about 4 mAh/cm². For example, FIG. 2 illustrates an example electrode 200 having an areal capacity greater than about 4 mAh/cm² to less than or equal to about 50 mAh/cm², and in certain aspects, optionally greater than or equal to about 4.5 mAh/cm² to less than or equal to about 7.5 mAh/cm² and an areal capacity variation of ±3%.

Electrode 200 may include positive electrode current collector 234 and one or more electroactive material layers 224, 226 disposed near or adjacent to the positive electrode current collector 234. For example, as illustrated, electrode 200 may include a first electroactive material layer 224 disposed near or adjacent to a first side of the positive electrode current collector 234, and a second electroactive material layer 226 disposed near or adjacent to a second side of the positive electrode current collector 234. Though two electroactive material layers 224, 226 are illustrated, the skilled artisan will recognized that the current teachings also apply to electrodes including only one electroactive material layer.

Like the positive electrode current collector 34 illustrated in FIG. 1, the positive electrode current collector 234 may be a metal foil (e.g., solid or meshed or clad foil), metal grid or screen, or expanded metal comprising aluminum or any other appropriate electrically conductive material known to those of skill in the art. In certain variations, a surface of a positive electrode current collector 234 may comprise a metal foil that is surface treated, for example, carbon coated and/or etched. In each instance, the positive electrode current collector 234 may have a thickness greater than or equal to about 5 μm to less than or equal to about 50 μm, and in certain aspects, optionally about 20 μm.

The first electroactive material layer 224 and the second electroactive material layer 226 may be the same or different. For example, each electroactive layer 224, 226 may have a thickness greater than or equal to about 150 μm to less than or equal to about 5 mm, and in certain aspects, optionally greater than or equal to about 150 μm to less than or equal to about 500 μm, and a thickness variation of ±5%. Like positive electrode 24 illustrated in FIG. 1, each electroactive layer 224, 226 may comprise a positive electroactive material including one or more lithium manganese iron phosphates (LiMnₓFe₁₋ₓPO₄, where 0≤x≤1) (LMFP), such as LiMn_{0.7}Fe_{0.3}PO₄, LiMn_{0.6}Fe_{0.4}PO₄, LiMn_{0.8}Fe_{0.2}PO₄, LiMn_{0.75}Fe_{0.25}PO₄, by way of non-limiting example. In certain aspects, the one or more lithium manganese iron phosphates (LiMnₓFe₁₋ₓPO₄, where 0≤x≤1) (LMFP), may be doped with one or more dopants, such as magnesium (Mg), aluminum (Al), yttrium (Y), scandium (Sc), and the like For example, the positive electroactive material may include one or more of LiMn_{0.7}Mg_{0.05}Fe_{0.25}PO₄, LiMn_{0.75}Al_{0.05}Fe_{0.2}PO₄, LiMn_{0.75}Al_{0.03}Fe_{0.22}PO₄, LiMn_{0.75}Al_{0.03}Fe_{0.22}PO₄, LiMn_{0.7}Y_{0.02}Fe_{0.28}PO₄, LiMn_{0.7}Mg_{0.02}Al_{0.03}Fe_{0.25}PO₄, and the like. The one or more lithium manganese iron phosphates (LiMnₓFe₁₋ₓPO₄, where 0≤x≤1) (LMFP) may be doped with about 10 wt. % of the one or more dopants.

Further still, like positive electrode 24, each electroactive layer 224, 226 may also include an electronically conducting material that provides an electron conduction path (such as, carbon black and/or vapor grown carbon fibers (VGCF)) and/or at least one polymeric binder material that improves the structural integrity of the electrode (such as, poly(tetrafluoroethylene) (PTFE)). For example, in certain variations, electroactive layers 224, 226 may each include about 89 wt. % of the one or more lithium manganese iron phosphates (LiMnₓFe₁₋ₓPO₄, where 0≤x≤1) (LMFP), about 6 wt. % of the one or more electrically conductive materials, and about 5 wt. % of the one or more binders.

The first and second electroactive material layers 224, 226 may be substantially homogenous layers having interparticle porosities greater than or equal to about 25 vol. % to less than or equal to about 60 vol. %, optionally greater than or equal to about 25 vol. % to less than or equal to about 35 vol. %, and in certain aspects, optionally greater than or equal to about 28 vol. % to less than or equal to about 32 vol. %. In certain variations, the first and second electroactive material layers 224, 226 may have a porosity distribution such that greater than or equal to about 68% (e.g., 1σ) of the interparticle porosity is greater than or equal to about 25 vol. % to less than or equal to about 35 vol. % and greater than or equal to about 95% (e.g., 2σ) of the interparticle porosity is greater than or equal to about 28 vol. % to less than or equal to about 32 vol. %. The first and second electroactive material layers 224, 226 may have electrode press densities greater than or equal to about 1.0 g/cc to less than or equal to about 3.0 g/cc, and in certain aspects, optionally greater than or equal to about 1.7 g/cc to less than or equal to about 2.7 g/cc, and a press density variation of ±3%.

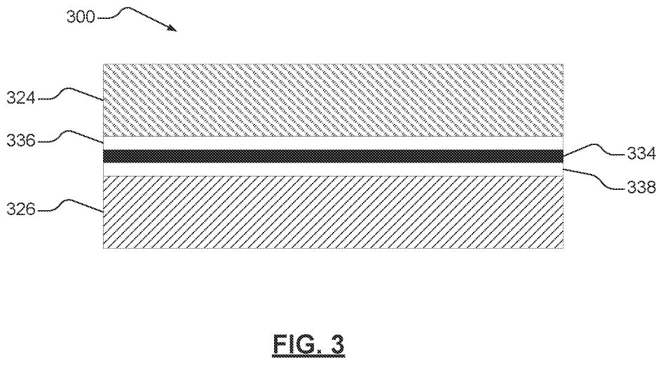

FIG. 3 illustrates another example electrode 300 having an areal capacity greater than about 4 mAh/cm² to less than or equal to about 50 mAh/cm², and in certain aspects, optionally greater than or equal to about 4.5 mAh/cm² to less than or equal to about 7.5 mAh/cm² and an areal capacity variation of ±3%. Electrode 300 may include a positive electrode current collector 334 and one or more electroactive material layers 324, 326 disposed near or adjacent to the positive electrode current collector 334. The electrode 300 may further include one or more electronically conductive adhesive layers 336, 338 disposed between the positive electrode current collector 334 and the one or more electroactive material layers 324, 326. For example, as illustrated, electrode 300 may include a first electronically conductive adhesive layer 336 disposed adjacent to a first surface of the positive electrode current collector 334, and a second electronically conductive adhesive layer 336 disposed adjacent to a second surface of the positive electrode current collector 334. A first electroactive material layer 324 may be disposed adjacent to an exposed surface of the first electronically conductive adhesive layer 336, and a second electroactive material layer 326 may be disposed adjacent to an exposed surface of the second electronically conductive adhesive layer 338. The first electronically conductive adhesive layer 336 may be disposed between the positive electrode current collector 334 and the first electroactive material layer 324. The second electronically conductive adhesive layer 338 may be disposed between the positive electrode current collector 334 and the second electroactive material layer 326. Though two electroactive material layers 324, 326 and two adhesive layers 336, 338 are illustrated, the skilled artisan will recognized that the current teachings also apply to electrodes including only one electroactive material layer and one adhesive layer.

Like the positive electrode current collector 34 illustrated in FIG. 1, the positive electrode current collector 334 may be a metal foil (e.g., solid or meshed or clad foil), metal grid or screen, or expanded metal comprising aluminum or any other appropriate electrically conductive material known to those of skill in the art. In certain variations, a surface of a positive electrode current collector 334 may comprise a metal foil that is surface treated, for example, carbon coated and/or etched. In each instance, the positive electrode current collector 334 may have a thickness greater than or equal to about 5 μm to less than or equal to about 50 μm, and in certain aspects, optionally about 20 μm.

The first electroactive material layer 324 and the second electroactive material layer 326 may be the same or different. For example, each electroactive layer 324, 326 may have a thickness greater than or equal to about 150 μm to less than or equal to about 2 mm, and in certain aspects, optionally greater than or equal to about 150 μm to less than or equal to about 500 μm, and a thickness variation of ±5%. Like positive electrode 24 illustrated in FIG. 1, each electroactive layer 324, 326 may comprise a positive electroactive material including one or more lithium manganese iron phosphates (LiMnₓFe₁₋ₓPO₄, where 0≤x≤1) (LMFP), such as LiMn_{0.7}Fe_{0.3}PO₄, LiMn_{0.6}Fe_{0.4}PO₄, LiMn_{0.8}Fe_{0.2}PO₄, LiMn_{0.75}Fe_{0.25}PO₄, by way of non-limiting example. In certain aspects, the one or more lithium manganese iron phosphates (LiMnₓFe₁₋ₓPO₄, where 0≤x≤1) (LMFP), may be doped with one or more dopants, such as magnesium (Mg), aluminum (Al), yttrium (Y), scandium (Sc), and the like. For example, the positive electroactive material may include one or more of LiMn_{0.7}Mg_{0.05}Fe_{0.25}PO₄, LiMn_{0.75}Al_{0.05}Fe_{0.2}PO₄, LiMn_{0.75}Al_{0.03}Fe_{0.22}PO₄, LiMn_{0.75}Al_{0.03}Fe_{0.22}PO₄, LiMn_{0.7}Y_{0.02}Fe_{0.28}PO₄, LiMn_{0.7}Mg_{0.02}Al_{0.03}Fe_{0.25}PO₄, and the like. The one or more lithium manganese iron phosphates (LiMnₓFe₁₋ₓPO₄, where 0≤x≤1) (LMFP) may be doped with about 10 wt. % of the one or more dopants

Further still, like positive electrode 24, each electroactive layer 324, 326 may also include an electronically conducting material that provides an electron conduction path (such as, carbon black and/or vapor grown carbon fibers (VGCF)) and/or at least one polymeric binder material that improves the structural integrity of the electrode (such as, poly(tetrafluoroethylene) (PTFE)). For example, electroactive layers 324, 326 may each include about 89 wt. % of the one or more lithium manganese iron phosphates (LiMnₓFe₁₋ₓPO₄, where 0≤x≤1) (LMFP), about 6 wt. % of the one or more electrically conductive materials, and about 5 wt. % of the one or more binders.

The first and second electroactive material layers 324, 326 may be substantially homogenous layers having interparticle porosities greater than or equal to about 25 vol. % to less than or equal to about 60 vol. %, optionally greater than or equal to about 25 vol. % to less than or equal to about 35 vol. %, and in certain aspects, optionally greater than or equal to about 28 vol. % to less than or equal to about 32 vol. %. In certain variations, the first and second electroactive material layers 324, 326 may have a porosity distribution such that greater than or equal to about 68% (e.g., 1σ) of the interparticle porosity is greater than or equal to about 25 vol. % to less than or equal to about 35 vol. % and greater than or equal to about 95% (e.g., 2σ) of the interparticle porosity is greater than or equal to about 28 vol. % to less than or equal to about 32 vol. %. The first and second electroactive material layers 324, 326 may have electrode press densities greater than or equal to about 1.0 g/cc to less than or equal to about 3.0 g/cc, and in certain aspects, optionally greater than or equal to about 1.7 g/cc to less than or equal to about 2.7 g/cc, and a press density variation of +3%.

Like the first and second electroactive material layers 324, 326, the first electronically conductive adhesive layer 336 and the second electronically conductive adhesive layer 338 may be the same or different. For example, each electronically conductive adhesive layer 336, 338 may have a thickness greater than or equal to about 0.5 μm to less than or equal to about 20 μm. Each electronically conductive adhesive layer 336, 338 may include one or more polymer components and one or more conductive fillers. For example, each electronically conductive adhesive layer 336, 338 may include greater than or equal to about 0.1 wt. % to less than or equal to about 50 wt. %, and in certain aspects, optionally greater than or equal to about 20 wt. % to less than or equal to about 40 wt. %, of mass ratio of the one or more conductive filler:one or more polymer components.

The one or more polymer components includes polymers that are solvent-resistant and that also provide good adhesion between the positive electrode current collector 334 and the first electroactive material layer 324 and/or the second electroactive material layer 326. For example, the one or more polymer components may include polyacrylic acid (PAA), epoxy, polyimide, polyester, polyacrylate, and vinyl ester, as well as less solvent resistant thermoplastic polymers, such as polyvinylidene fluoride (PVdF), polyamide, silicon, and acrylic. The one or more conductive fillers may be carbon-based materials. For example, the one or more conductive fillers may be selected from carbon black, graphene, carbon nanotubes, carbon nanofibers, metal powders (such as, silver (Ag), nickel (Ni), aluminum (Al) and/or RuO₂), and conductive polymers In certain variations, when the one or more conductive fillers include carbon black and the one or more polymer components includes polyacrylate (PAA), the electronically conductive adhesive layers 336, 338 may have a mass ratio (SP:PAA) of about 1:3. In still further variations, such as when he one or more conductive fillers include carbon nanotubes and the one or more polymer components includes polyvinylidene fluoride (PVdF), the electronically conductive adhesive layers 336, 338 may have a mass ratio (SWCNT:PVDF) of about 0.2%.

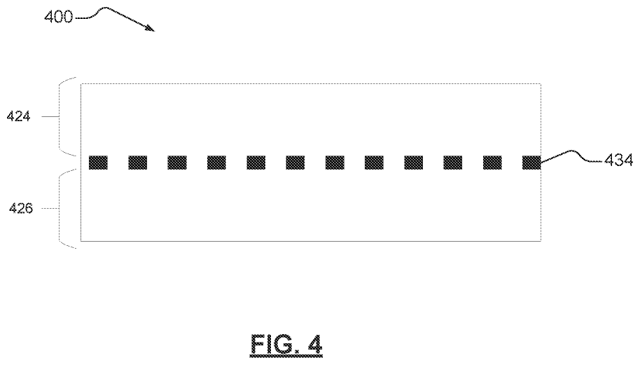

FIG. 4 illustrates another example electrode 400 having an areal capacity greater than about 4 mAh/cm² to less than or equal to about 50 mAh/cm², and in certain aspects, optionally greater than or equal to about 4.5 mAh/cm² to less than or equal to about 7.5 mAh/cm² and an areal capacity variation of ±3%. Electrode 400 may include positive electrode current collector 434 and one or more electroactive material layers 424, 426 disposed near or adjacent to the positive electrode current collector 434. For example, as illustrated, electrode 400 may include a first electroactive material layer 424 disposed near or adjacent to a first side of the positive electrode current collector 434, and a second electroactive material layer 426 disposed near or adjacent to a second side of the positive electrode current collector 434. Though two electroactive material layers 424, 426 are illustrated, the skilled artisan will recognized that the current teachings also apply to electrodes including only one electroactive material layer.

The positive electrode current collector 434 may be a meshed current collector having a thickness greater than or equal to about 5 μm to less than or equal to about 50 μm, and in certain aspects, optionally about 23 μm. For example, in certain variations, the meshed current collector 434 may comprise an aluminum foil prepared using a known method, such as punching and/or laser and pinning. The meshed current collector 434 may have a porosity ranging from greater than or equal to about 0.01 vol. % to less than or equal to about 50 vol. % and an average pore size greater than or equal to about 5 nm to less than or equal to about 500 μm. Meshed current collectors, like meshed current collector 434, may be advantageous in instances of Li-prelithitation of the, or within, a battery including electrode 400. Further still meshed current collectors, like meshed current collector 434, may be advantageous insofar as the positive electroactive material of the first electroactive material layer 424 and/or the second electroactive material layer 426 can be pressed into the pores of the meshed current collector 434, for example, via a hot pressing fabricating process.

The first electroactive material layer 424 and the second electroactive material layer 426 may be the same or different. For example, each electroactive layer 424, 426 may have a thickness greater than or equal to about 150 μm to less than or equal to about 2 mm, and in certain aspects, optionally greater than or equal to about 150 μm to less than or equal to about 500 μm, and a thickness variation of +5%. Like positive electrode 24 illustrated in FIG. 1, each electroactive layer 424, 426 may comprise a positive electroactive material including one or more lithium manganese iron phosphates (LiMnₓFe₁₋ₓPO₄, where 0≤x≤1) (LMFP), such as LiMn_{0.7}Fe_{0.3}PO₄, LiMn_{0.6}Fe_{0.4}PO₄, LiMn_{0.8}Fe_{0.2}PO₄, LiMn_{0.75}Fe_{0.25}PO₄, by way of non-limiting example. In certain aspects, the one or more lithium manganese iron phosphates (LiMnₓFe₁₋ₓPO₄, where 0≤x≤1) (LMFP), may be doped with one or more dopants, such as magnesium (Mg), aluminum (Al), yttrium (Y), scandium (Sc), and the like. For example, the positive electroactive material may include one or more of LiMn_{0.7}Mg_{0.05}Fe_{0.25}PO₄, LiMn_{0.75}Al_{0.05}Fe_{0.2}PO₄, LiMn_{0.75}Al_{0.03}Fe_{0.22}PO₄, LiMn_{0.75}Al_{0.03}Fe_{0.22}PO₄, LiMn_{0.7}Y_{0.02}Fe_{0.28}PO₄, LiMn_{0.7}Mg_{0.02}Al_{0.03}Fe_{0.25}PO₄, and the like. The one or more lithium manganese iron phosphates (LiMnₓFe₁₋ₓPO₄, where 0≤x≤1) (LMFP) may be doped with about 10 wt. % of the one or more dopants.

Further still, like positive electrode 24, each electroactive layer 424, 426 may also include an electronically conducting material that provides an electron conduction path (such as, carbon black and/or vapor grown carbon fibers (VGCF)) and/or at least one polymeric binder material that improves the structural integrity of the electrode (such as, poly(tetrafluoroethylene) (PTFE)). For example, in certain variations, electroactive layers 424, 426 may each include about 89 wt. % of the one or more lithium manganese iron phosphates (LiMnₓFe₁₋ₓPO₄, where 0≤x≤1) (LMFP), about 6 wt. % of the one or more electrically conductive materials, and about 5 wt. % of the one or more binders. In other variations, electroactive layers 424, 426 may each include about 95 wt. % of the one or more lithium manganese iron phosphates (LiMnₓFe₁₋ₓPO₄, where 0≤x≤1) (LMFP), about 2 wt. % of the one or more electrically conductive materials, and about 3 wt. % of the one or more binders

The first and second electroactive material layers 424, 426 may be substantially homogenous layers having interparticle porosities greater than or equal to about 25 vol. % to less than or equal to about 60 vol. %, optionally greater than or equal to about 25 vol. % to less than or equal to about 35 vol. %, and in certain aspects, optionally greater than or equal to about 28 vol. % to less than or equal to about 32 vol. %. In certain variations, the first and second electroactive material layers 424, 426 may have a porosity distribution such that greater than or equal to about 68% (e.g., 1σ) of the interparticle porosity is greater than or equal to about 25 vol. % to less than or equal to about 35 vol. % and greater than or equal to about 95% (e.g., 2σ) of the interparticle porosity is greater than or equal to about 28 vol. % to less than or equal to about 32 vol. %. The first and second electroactive material layers 424, 426 may have electrode press densities greater than or equal to about 1.0 g/cc to less than or equal to about 3.0 g/cc, and in certain aspects, optionally greater than or equal to about 1.7 g/cc to less than or equal to about 2.7 g/cc, and a press density variation of ±3%.

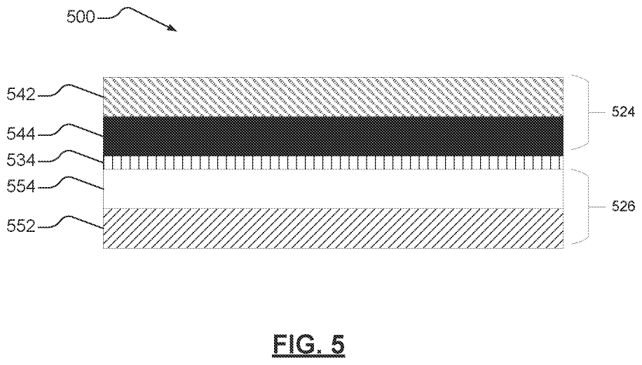

FIG. 5 illustrates another example electrode 500 having an areal capacity greater than about 4 mAh/cm² to less than or equal to about 50 mAh/cm², and in certain aspects, optionally greater than or equal to about 4.5 mAh/cm² to less than or equal to about 7.5 mAh/cm² and an areal capacity variation of ±3%. Electrode 500 may include a positive electrode current collector 534 and one or more electroactive material layers 524, 526 disposed near or adjacent to the positive electrode current collector 534. For example, as illustrated, electrode 500 may include a first electroactive material layer 524 disposed near or adjacent to a first side of the positive electrode current collector 534, and a second electroactive material layer 526 disposed near or adjacent to a second side of the positive electrode current collector 534. Though two electroactive material layers 524, 526 are illustrated, the skilled artisan will recognized that the current teachings also apply to electrodes including only one electroactive material layer.

The first electroactive material layer 524 and the second electroactive material layer 526 may each comprise one or more sublayers 542, 544, 552, 554. The one or more sublayers 542, 544, 552, 554 may be disposed such that sublayers 544, 554 disposed nearer to the positive electrode current collector 534 have interparticle porosities that are less than interparticle porosities of sublayers 542, 552 disposed further from the positive electrode current collector 534. For example, the first and second electroactive material layers 524, 526 may each a first sublayer 544, 554 having a first interparticle porosity and a second sublayer 542, 552 having a second interparticle porosity. The second interparticle porosity is greater than the first interparticle porosity. Although the illustrated example includes only two sub-layers disposed on or adjacent to each side of the current collector 534, the skilled artisan will recognize that the current teachings extend to various other configurations, including those having three or more sublayers disposed on or adjacent to each side of the current collector 534.

As illustrated, the first electroactive material layer 524 may have a first sublayer 544 having a first interparticle porosity disposed near or adjacent to a first side of the positive electrode current collector 534 and a second sublayer 542 having a second interparticle porosity disposed near or adjacent to an exposed surfaces of the first sublayer 544. The second electroactive material layer 526 may have a first sublayer 554 having a first interparticle porosity disposed near or adjacent to a second side of the positive electrode current collector 534 and a second sublayer 552 having a second interparticle porosity disposed near or adjacent to an exposed surfaces of the first sublayer 554. In each instance, the first interparticle porosity may be greater than or equal to about to about 20 vol. % to less than or equal to about 45 vol. %, and in certain aspects, optionally about 32 vol. %. The second interparticle porosity may be greater than or equal to about to about 20 vol. % to less than or equal to about 45 vol. %, and in certain aspects, optionally about 35 vol. %.

The first electroactive material layer 524 and the second electroactive material layer 526 may be the same or different. Likewise, in each instance, the first and second sublayers 542, 544, 522, 554 may be the same or different. For example, each electroactive layer 324, 326 may have an overall thickness greater than or equal to about 150 μm to less than or equal to about 5 mm, and in certain aspects, optionally greater than or equal to about 150 μm to less than or equal to about 500 μm, and a thickness variation of ±5%. In various aspects, the first sublayer 544, 554 may have a first thickness that is substantially equal to a second thickness of the second sublayer 542, 552. The first sublayer 544, 554 (in each instance) may have a thickness greater than or equal to about 20 μm to less than or equal to about 2000 μm, and in certain aspects, optionally about 150 μm. Likewise, the second sublayer 542, 552 (in each instance. may have a thickness greater than or equal to about 20 μm to less than or equal to about 2000 μm, and in certain aspects, optionally about 150 μm.

Like positive electrode 24 illustrated in FIG. 1, each sublayer 542, 544, 522, 554 may comprise a positive electroactive material including one or more lithium manganese iron phosphates (LiMnₓFe₁₋ₓPO₄, where 0≤x≤1) (LMFP), such as LiMn_{0.7}Fe_{0.3}PO₄, LiMn_{0.6}Fe_{0.4}PO₄, LiMn_{0.8}Fe_{0.2}PO₄, LiMn_{0.75}Fe_{0.25}PO₄, by way of non-limiting example. In certain aspects, the one or more lithium manganese iron phosphates (LiMnₓFe₁₋ₓPO₄, where 0≤x≤1) (LMFP), may be doped with one or more dopants, such as magnesium (Mg), aluminum (Al), yttrium (Y), scandium (Sc), and the like. For example, the positive electroactive material may include one or more of LiMn_{0.7}Mg_{0.05}Fe_{0.25}PO₄, LiMn_{0.75}Al_{0.05}Fe_{0.2}PO₄, LiMn_{0.75}Al_{0.03}Fe_{0.22}PO₄, LiMn_{0.75}Al_{0.03}Fe_{0.22}PO₄, LiMn_{0.7}Y_{0.02}Fe_{0.28}PO₄, LiMn_{0.7}Mg_{0.02}Al_{0.03}Fe_{0.25}PO₄, and the like. The one or more lithium manganese iron phosphates (LiMnₓFe₁₋ₓPO₄, where 0≤x≤1) (LMFP) may be doped with about 10 wt. % of the one or more dopants.

Further still, like positive electrode 24, each sublayer 542, 544, 522, 554 may also include an electronically conducting material that provides an electron conduction path (such as, carbon black and/or vapor grown carbon fibers (VGCF)) and/or at least one polymeric binder material that improves the structural integrity of the electrode (such as, poly(tetrafluoroethylene) (PTFE)). For example, in certain variations, the first sublayer 544, 554 may comprise LiMn_{0.7}Fe_{0.3}PO₄ and the second sublayer 542, 552 may include LiMn_{0.6}Fe₄PO₄. The first sublayer 554, 554 may include 89 wt. % of the one or more lithium manganese iron phosphates (LiMnₓFe₁₋ₓPO₄, where 0≤x≤1) (LMFP), about 6 wt. % of the one or more electrically conductive materials, and about 5 wt. % of the one or more binders. The second sublayer 542, 552 may include 93.5 wt. % of the one or more lithium manganese iron phosphates (LiMnₓFe₁₋ₓPO₄, where 0≤x≤1) (LMFP), about 1.5 wt. % of the one or more electrically conductive materials, and about 5 wt. % of the one or more binders. The second sublayer 542, 552 may have an average particle size that is smaller than the average particle size of the first sublayer 544, 554. For example, the second sublayer 542, 552 may an average secondary particle size (D50) of about 2 μm, and the first sublayer 544, 554 may an average secondary particle size (D50) of about 3 μm.

Like the positive electrode current collector 34 illustrated in FIG. 1, the positive electrode current collector 534 may be a metal foil (e.g., solid or meshed or clad foil), metal grid or screen, or expanded metal comprising aluminum or any other appropriate electrically conductive material known to those of skill in the art. In certain variations, a surface of a positive electrode current collector 534 may comprise a metal foil that is surface treated, for example, carbon coated and/or etched. In each instance, the positive electrode current collector 534 may have a thickness greater than or equal to about 5 μm to less than or equal to about 50 μm, and in certain aspects, optionally about 20 μm.

The thick electrodes detailed herein, for example as illustrated in FIGS. 1-5 may be prepared using one or more of the methods detailed in the concurrently filed application titled “Fabrication Process to Make Electrodes by Rolling,” the entire disclosure of which is incorporated by reference herein.

Certain features of the current technology are further illustrated in the following non-limiting examples.

### Example 1

An example half coin cell can be prepared in accordance with various aspects of the present disclosure. The example cell can include thick electrodes in accordance with various aspects of the present disclosure. For example, the example cell can include an electrode having a thickness of about 290 μm. The electrode may include one or more electroactive material layers including about 89 wt. % of the one or more lithium manganese iron phosphates (LiMnₓFe₁₋ₓPO₄, where 0≤x≤1) (LMFP), about 6 wt. % of the one or more electrically conductive materials (e.g., VGCF), and about 5 wt. % of the one or more binders (e.g., poly(tetrafluoroethylene) (PTFE)). The electrode may have a surface area of about 1.5386 cm².

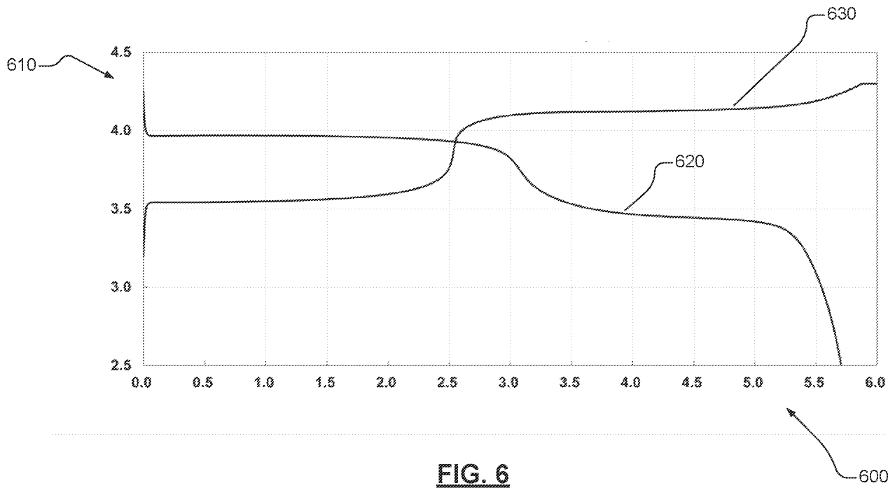

FIG. 6 illustrates an areal capacity (mAh/cm²) and voltage (V) for the example cell. For example, line 620 represents the discharge curve of LMFP electrode at C/10, and line 630 represents the charge curve of LMFP electrode at C/10 including constant voltage charge. The x-axis 600 represents areal capacity (mAh/cm²). The y-axis 610 represents voltage (V).

### Example 2

An example half coin cell can be prepared in accordance with various aspects of the present disclosure. The example cell can include thick electrodes in accordance with various aspects of the present disclosure. For example, the example cell can include an electrode having a thickness of about 220 μm. The electrode may include one or more electroactive material layers including about 93.5 wt. % of the one or more lithium manganese iron phosphates (LiMnₓFe₁₋ₓPO₄, where 0≤x≤1 (e.g., x=0.6)) (LMFP), about 1.5 wt. % of the one or more electrically conductive materials (e.g., KETJENBLACK® (KB)), and about 5 wt. % of the one or more binders (e.g., poly(tetrafluoroethylene) (PTFE)). The electrode may have a surface area of about 1.5386 cm².

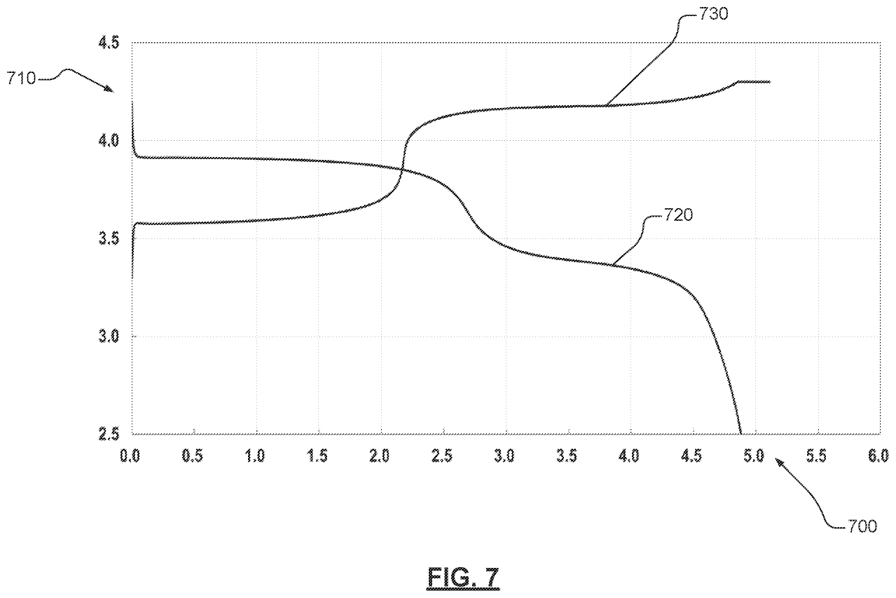

FIG. 7 illustrates an areal capacity (mAh/cm²) and voltage (V) for the example cell. For example, line 720 represents the discharge curve of LMFP electrode at C/10, and line 730 represents the charge curve of LMFP electrode at C/10 including constant voltage charge. The x-axis 700 represents areal capacity (mAh/cm²). The y-axis 710 represents voltage (V).

### Example 3

An example half coin cell can be prepared in accordance with various aspects of the present disclosure. The example cell can include thick electrodes in accordance with various aspects of the present disclosure. For example, the example cell can include an electrode having a thickness of about 330 μm. The electrode may include one or more electroactive material layers including about 78 wt. % of the one or more lithium manganese iron phosphates (LiMnₓFe₁₋ₓPO₄, where 0≤x≤1 (e.g., x=0.7)) (LMFP), about 12 wt. % of the one or more electrically conductive materials (e.g., 10 wt. % of Super-P and 2 wt. % of graphite (e.g., KS6)), and about 10 wt. % of the one or more binders (e.g., poly(tetrafluoroethylene) (PTFE)). The electrode may have a surface area of about 1.5386 cm².

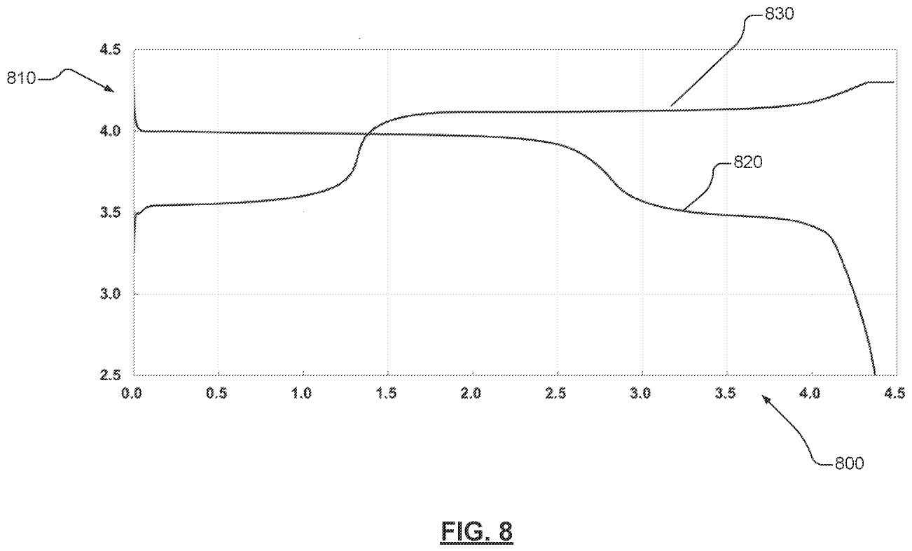

FIG. 8 illustrates an areal capacity (mAh/cm²) and voltage (V) for the example cell. For example, line 820 represents the discharge curve of LMFP electrode at C/10, and line 830 represents the charge curve of LMFP electrode at C/10 including constant voltage charge. The x-axis 800 represents areal capacity (mAh/cm²). The y-axis 810 represents voltage (V).

### Example 4

An example pouch call can be prepared in accordance with various aspects of the present disclosure. The example cell can include thick electrodes in accordance with various aspects of the present disclosure. For example, the example cell can include a positive electrode having a thickness of about 240 μm. The positive electrode may include one or more electroactive material layers including about 89 wt. % of the one or more lithium manganese iron phosphates (LiMnₓFe₁₋ₓPO₄, where 0≤x≤1 (e.g., x=0.6)) (LMFP), about 6 wt. % of the one or more electrically conductive materials (e.g., 4 wt. % of Super-P and 2 wt. % of VGCF), and about 5 wt. % of the one or more binders (e.g., poly(tetrafluoroethylene) (PTFE)). The electrode may have a surface area of about 27.5 cm². The negative electrode may include graphite. For example, the negative electrode may include one or more electroactive material layers including about 97.5 wt. % of graphite, about 1 wt. % of the one or more electrically conductive materials (e.g., Super-P), and about 1.5 wt. % of the one or more binders (e.g., CMC+SBR).

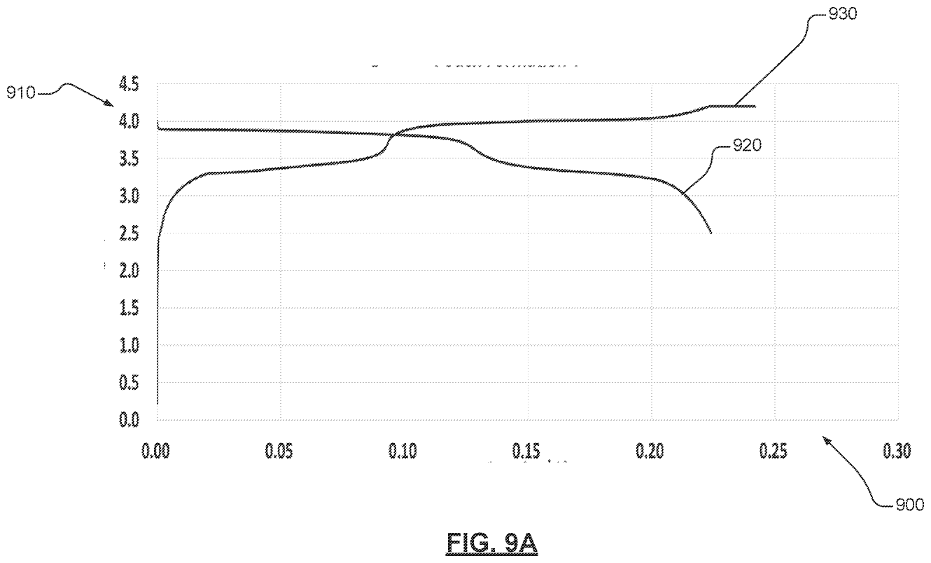

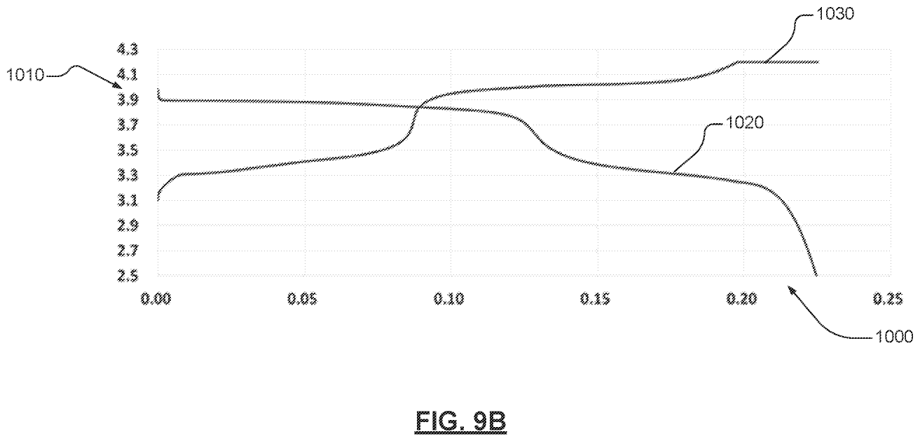

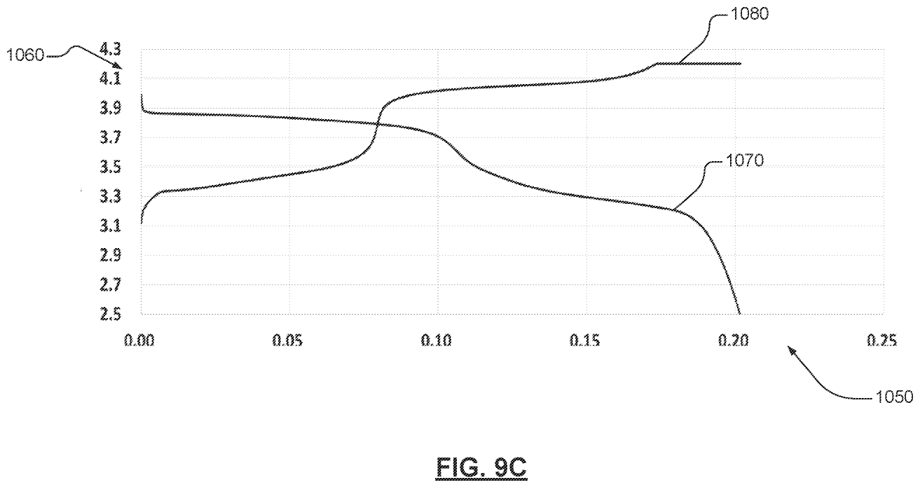

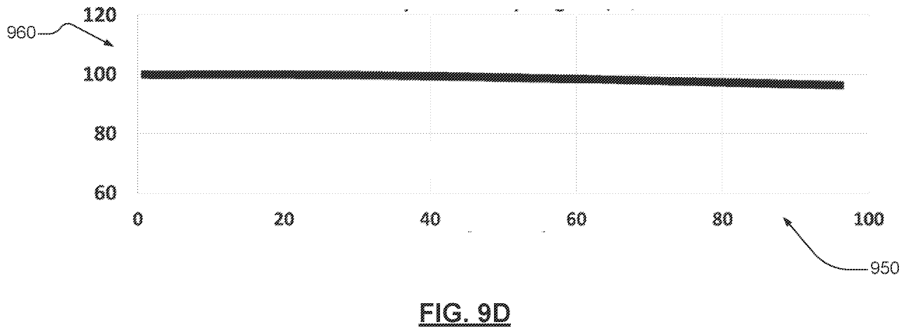

FIG. 9A illustrates capacity (Ah) and voltage (V) of the formation cycle for the example LMFP-Graphite pouch cell. For example, line 920 represents the discharge curve of LMFP electrode at C/10, and line 930 represents the charge curve of LMFP electrode at C/20 including constant voltage charge. The x-axis 900 represents capacity (Ah). The y-axis 910 represents voltage (V). The first Coulombic efficiency is 92.4%.

FIG. 9B illustrates a capacity (Ah) and voltage (V) of the for the example LMFP-Graphite pouch cell at C/10. For example, line 1020 represents the discharge curve of LMFP electrode at C/10, and line 1030 represents the charge curve of LMFP electrode at C/10 including constant voltage charge. The x-axis 1000 represents capacity (Ah). The y-axis 1010 represents voltage (V).

FIG. 9C illustrates a capacity (Ah) and voltage (V) of the for the example LMFP-Graphite pouch cell at C/3. For example, line 1070 represents the discharge curve of LMFP electrode at C/3, and line 1080 represents the charge curve of LMFP electrode at C/3 including constant voltage charge. The x-axis 1050 represents capacity (Ah). The y-axis 1060 represents voltage (V).

FIG. 9D illustrates the capacity retention (%) for the example LMFP-Graphite pouch cell at 25° C. For example, the x-axis 950 represents cycle number, and the y-axis 960 represents capacity retention (%).

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrode for an electrochemical cell, the electrode comprising:
a current collector; and
one or more electroactive material layers disposed adjacent to one or more exposed surfaces of the current collector, wherein the one or more electroactive material layers each comprise lithium manganese iron phosphate (LiMnₓFe₁₋ₓPO₄, where 0≤x≤1) (LMFP) and have a thickness greater than about 150 μm to less than or equal to about 5 mm, and wherein the electrode has an areal capacity greater than about 4 mAh/cm² to less than or equal to about 50 mAh/cm².

2. The electrode of claim 1, wherein the electrode further comprises one or more electronically conductive adhesive layers disposed between the current collector and the one or more electroactive material layers.

3. The electrode of claim 2, wherein each of the one or more electronically conductive adhesive layers has a thickness greater than or equal to about 0.5 μm to less than or equal to about 20 μm.

4. The electrode of claim 2, wherein each of the one or more electronically conductive adhesive layers comprises greater than or equal to about 0.1 wt. % to less than or equal to about 50 wt. % of one or more polymer components, and greater than or equal to about 0.1 wt. % to less than or equal to about 50 wt. % of one or more conductive fillers.

5. The electrode of claim 4, wherein the one or more polymer components is selected from the group consisting of polyacrylic acid (PAA), epoxy, polyimide, polyester, polyacrylate, vinyl ester, polyvinylidene fluoride (PVdF), polyamide, silicon, acrylic, and combinations thereof, and
wherein the one or more conductive fillers are selected from the group consisting of carbon black, graphene, carbon nanotubes, carbon nanofibers, metal powders, conductive polymers, and combinations thereof.

6. The electrode of claim 1, wherein the current collector is a meshed current collector having a porosity greater than or equal to about 0.01 vol. % to less than or equal to about 50 vol. % and an average pore size greater than or equal to about 5 nm to less than or equal to about 500 μm.

7. The electrode of claim 6, wherein the one or more electroactive material layers are pressed into pores of the meshed current collector during fabrication.

8. The electrode of claim 1, wherein at least one of the one or more electroactive material layers comprises one or more sublayers having different interparticle porosities, wherein sublayers of the one or more sublayers having lower interparticle porosities are disposed nearer to the current collector and sublayers of the one or more sublayers having higher interparticle porosities are disposed further from the current collector.

9. The electrode of claim 8, wherein the one or more sublayers comprise a first sublayer having a first interparticle porosity and a second sublayer having a second interparticle porosity, wherein the second interparticle porosity is larger than the first interparticle porosity and the first sublayer is disposed adjacent to the current collector and the second sublayer is disposed adjacent to an exposed surface of the first sublayer.

10. The electrode of claim 1, wherein at least one of the one or more electroactive material layers has a thickness greater than about 150 μm to less than or equal to about 500 μm, and the areal capacity is greater than or equal to about 4.5 mAh/cm² to less than or equal to about 7.5 mAh/cm².

11. The electrode of claim 1, wherein the at least one of the one or more electroactive material layers comprises one or more of LiMn_{0.7}Fe_{0.3}PO₄, LiMn_{0.6}Fe_{0.4}PO₄, LiMn_{0.8}Fe_{0.2}PO₄ and LiMn_{0.75}Fe_{0.25}PO₄.

12. The electrode of claim 1, wherein the one or more electroactive material layers are doped with one or more dopants selected from magnesium (Mg), aluminum (Al), yttrium (Y), scandium (Sc), and combinations thereof.

13. The electrode of claim 1, wherein the electrode has a press density of greater than or equal to about 1.0 g/cc to less than or equal to about 3.0 g/cc and an interparticle porosity greater than or equal to about 25 vol. % to less than or equal to about 60 vol. %.

14. The electrode of claim 1, wherein at least one of the one or more electroactive material layers comprises greater than or equal to about 80 wt. % to less than or equal to about 98 wt. % of the lithium manganese iron phosphate (LiMnₓFe₁₋ₓPO₄, where 0≤x≤1) (LMFP), and
wherein the at least one of the one or more electroactive material layers further comprises:
greater than or equal to about 0.5 wt. % to less than or equal to about 10 wt. % of one or more binders; and
greater than or equal to about 0.5 wt. % to less than or equal to about 15 wt. % of one or more conductive fillers.

15. An electrode for an electrochemical cell, the electrode comprising:
a current collector;
an electroactive material layer, wherein the electroactive material layer comprises lithium manganese iron phosphate (LiMnₓFe₁₋ₓPO₄, where 0≤x≤1) (LMFP) and has a thickness greater than about 150 μm to less than or equal to about 500 μm; and
an electronically conductive adhesive layer disposed between the current collector and the electroactive material layer, wherein the electronically conductive adhesive layer comprises greater than or equal to about 0.1 wt. % to less than or equal to about 50 wt. % of one or more polymer components, and greater than or equal to about 0.1 wt. % to less than or equal to about 50 wt. % of one or more conductive fillers and has a thickness greater than or equal to about 0.5 μm to less than or equal to about 20 μm.

16. The electrode of claim 15, wherein the current collector is a meshed current collector having a porosity greater than or equal to about 0.01 vol. % to less than or equal to about 50 vol. % and an average pore size greater than or equal to about 5 nm to less than or equal to about 500 μm.

17. The electrode of claim 15, wherein the electroactive material layer comprises a first sublayer having a first interparticle porosity and a second sublayer having a second interparticle porosity, wherein the second interparticle porosity is larger than the first interparticle porosity and the first sublayer is disposed adjacent to the current collector and the second sublayer is disposed adjacent to an exposed surface of the first sublayer.

18. An electrode for an electrochemical cell, the electrode comprising:
a current collector; and
an electroactive material layer disposed adjacent to an exposed surface of the current collector, wherein the electroactive material layer has a thickness greater than about 150 μm to less than or equal to about 500 μm, and wherein the electroactive material layer comprises:
a first sublayer having a first interparticle porosity, and
a second sublayer having a second interparticle porosity, wherein the second interparticle porosity is larger than the first interparticle porosity and the first sublayer is disposed adjacent to the current collector and the second sublayer is disposed adjacent to an exposed surface of the first sublayer, and wherein the first sublayer and the second sublayer each comprises lithium manganese iron phosphate (LiMnₓFe₁₋ₓPO₄, where 0≤x≤1) (LMFP).

19. The electrode of claim 18, wherein the current collector is a meshed current collector having a porosity greater than or equal to about 0.01 vol. % to less than or equal to about 50 vol. % and an average pore size greater than or equal to about 5 nm to less than or equal to about 500 μm.

20. The electrode of claim 18, wherein the electrode further comprises:
an electronically conductive adhesive layer disposed between the current collector and the first sublayer, wherein the electronically conductive adhesive layer has a thickness greater than or equal to about 0.5 μm to less than or equal to about 20 μm.
